(19) United States
(12) Patent Application Publication
(10) Pub. No.: US 2024/0114275 A1
(43) Pub. Date: Apr. 4, 2024

(54) LOUDSPEAKER DEVICE

(71) Applicant: Kuo Su, Xuancheng (CN)

(72) Inventor: Kuo Su, Xuancheng (CN)

(21) Appl. No.: 18/534,981

(22) Filed: Dec. 11, 2023

(30) Foreign Application Priority Data
Jun. 26, 2023 (CN) 202321625406.X

(51) Int. Cl. H04R 1/02

(52) U.S. Cl. CPC H04R 1/028

(57) ABSTRACT

Disclosed is a loudspeaker device, including a translucent inner casing, and a transparent or translucent outer casing fixed on an outer side of the inner casing, a light-emitting device being fixed inside the inner casing, the outer casing and the inner casing each being provided at least one through hole, an outward extension position extending outwardly being arranged on the through hole of the inner casing, at least one connecting segment connected to the light-emitting device is arranged inside the inner casing, the inner casing includes a first inner casing and a second inner casing, and the outer casing includes a first outer casing and a second outer casing, and a part of a speaker located inside the loudspeaker device is arranged on an inner side outward extension position.

### TECHNICAL FIELD

The present disclosure belongs to the field of sound playing equipment, and particularly relates to a loudspeaker device.

### BACKGROUND

Speaker structures on the market are diversified, but their overall external structures are relatively single. Some light-emitting loudspeaker structures come into being, however, common light-emitting loudspeakers are provided with light-emitting devices outside the loudspeakers, thereby making the loudspeakers realize the light-emitting effect on the whole.

The present disclosure provides a loudspeaker device, so that when the emitting light, a speaker will have a suspended/hidden visual effect, providing a better visual experience.

### SUMMARY

In view of this, the present disclosure provides a loudspeaker device.

In order to implement the above objective, the present disclosure provides a technical solution as follows: including a translucent inner casing, and a transparent or translucent outer casing fixed on an outer side of the inner casing, a light-emitting device being fixed inside the inner casing, the outer casing and the inner casing each being provided at least one through hole, and an outward extension position extending outwardly being arranged on the through hole of the inner casing.

Further, the through holes are at least one second through hole formed on the outer casing and at least one first through hole formed on the inner casing, and the first through hole and the second through hole are penetrated through each other.

Further, the outward extension position is arranged on an outer side of the first through hole, and a necking extending to the second through hole is formed on an end portion of the outward extension position.

Further, at least one connecting segment connected to the light-emitting device is arranged inside the inner casing.

Further, the inner casing includes a first inner casing and a second inner casing, and the outer casing includes a first outer casing and a second outer casing.

Further, the first outer casing and the second outer casing are fixed on an outer side of the inner casing.

Further, cover plates are fixed on both sides of the outer casing and the inner casing.

Further, a top plate is fixed on the top of the inner casing, and a base is fixed on the bottom of the inner casing.

Further, a speaker is fixed on the first through hole and the second through hole.

Further, a part of the speaker located inside the loudspeaker device is arranged on an inner side outward extension position.

Compared with the prior art, the loudspeaker device provided in the present disclosure has the following advantages:
1. The loudspeaker has a unique light-emitting effect, when the loudspeaker device is in the light-emitting state, the user cannot observe the speaker inside the loudspeaker, making the speaker present a suspended unique visual effect.
2. The loudspeaker device in the present disclosure is assembled using multi-modular splicing, featuring a lower overall costs and relatively convenient for assembly.

### BRIEF DESCRIPTION OF THE DRAWINGS

In order to more clearly illustrate the technical solution in the embodiments of the present disclosure, the accompanying drawings required to be used in the embodiments or the prior art description are simply introduced below, and obviously, the accompanying drawings described below are only some embodiments of the present disclosure, such that for those of ordinary skill in the art, other drawings may further be derived from these drawings without making inventive efforts.

FIG. 1 is an overall schematic diagram of components of an embodiment of the present disclosure.

FIG. 2 is a schematic structural diagram of a side surface of an embodiment of the present disclosure with an outer casing removed.

FIG. 3 is a schematic structural diagram of a side surface of an embodiment of the present disclosure with an inner casing removed.

FIG. 4 is a schematic structural diagram of an inner casing of an embodiment of the present disclosure.

FIG. 5 is a schematic side view of an embodiment of the present disclosure.

FIG. 6 is sectional view of an embodiment of the present disclosure.

Reference numerals in the accompanying drawings:

| Name | Numeral |
|---|---|
| Outer | 1 |
| casing | |
| Inner | 2 |
| casing | |
| Base | 3 |
| Light- | 5 |
| emitting | |
| device | |
| Cover plate | 7 |
| Carrying | 8 |
| handle | |
| First outer | 11 |
| casing | |
| First inner | 21 |
| casing | |
| Speaker | 4 |
| Top plate | 6 |
| First | 23 |
| through hole | |
| Outward | 24 |
| extension | |
| position | |
| Second outer | 12 |
| casing | |
| Second inner | 22 |
| casing | |
| Connecting | 26 |
| segment | |
| Button slot | 61 |
| Second | 13 |
| through hole | |
| Necking | 25 |

### DETAILED DESCRIPTIONS OF THE EMBODIMENTS

In order to better understand the technical solution of the present disclosure, the present disclosure is further described in detail below in conjunction with particular

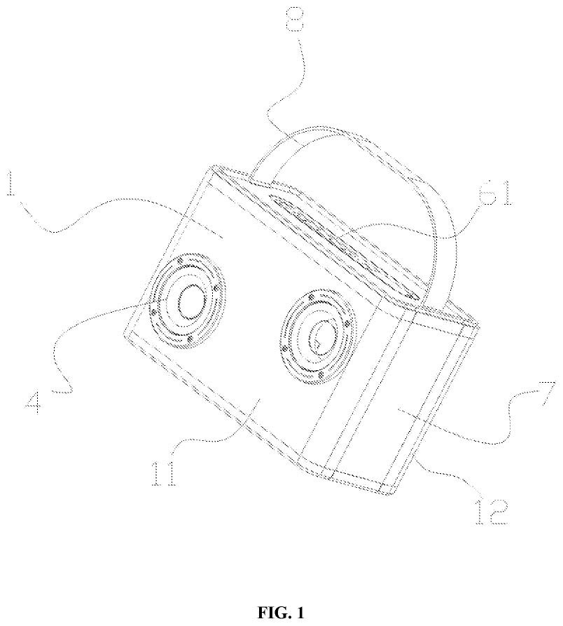

As shown in FIGS. 1-6, an embodiment of the present disclosure provides a loudspeaker device.

As shown in FIGS. 1-3, in this embodiment, the loudspeaker device includes an outer casing 1, an inner casing 2, a base 3, a speaker 4, and the like.

The inner casing 2 is arranged on the base 3 in a detachable mode, including but not limited to a bolt connection, a snap-fitting connection, and the like. In this embodiment, the inner casing 2 is divided into a first inner casing 21 and a second inner casing 22, and in other optional embodiments, the inner casing 2 can be integrally formed.

As shown in FIG. 4, the first inner casing 21 and the second inner casing 22 are arranged on the base 3 in a detachable connection, and the first inner casing 21 and the second inner casing 22 are connected to each other in a detachable connection, which can be a bolt connection, a snap-fitting connection, and other detachable connection modes known to those skilled in the art.

It is worth noting that all the detachable connections in the present disclosure can be bolt connections, snap-fitting connections, snap-in connections, magnetic connections, and the like, and other detachable connection modes known to those skilled in the art in the art, which will not be repeated below.

As shown in FIG. 4, in a preferred embodiment, an overall shape of the inner casing 2 can be rectangular, spherical, triangular, or polygonal, and is not specifically limited here. In a preferred embodiment of the present disclosure, the overall shape of the inner casing 2 is rectangular, and the inner casing 2 is a rectangular closed frame, which also includes a top surface and a bottom surface.

The inner casing and the outer casing are spliced and formed by using more than two segments of a combined casing, which has beneficial effects of reducing production costs and improving product yield.

The inner casing 2 is made of a translucent material with good light transmittance, so that light emitted from the inside of the inner casing 2 can transmit through the inner casing 2, causing the inner casing 2 to show a light-emitting and bright state. It is worth noting that the inner casing 2 can be understood to be translucent, that is, a user cannot observe an interior structural shape of the inner casing 2 when he/she observes the inner casing from the outside, but the inner casing 2 can emit the light from a light-emitting device, so that the inner casing 2 will be light-emitting and bright as a whole when it is in use.

A plurality of transverse connecting segments 26 are arranged inside the inner casing 2, connecting holes are formed on the connecting segments 26, and the connecting segments 26 are connected to the light-emitting device 5 in a detachable connection.

The outer casing 1 is arranged outside the inner casing 2, and the outer casing 1 is fixed above the base 3 in a detachable connection mode. In a preferred embodiment of the present disclosure, the outer casing 1 consists of a first outer casing 11 and a second outer casing 12 spliced together in a detachable connection mode. A certain spacing is reserved between inner walls of long end surfaces on two sides of the outer casing 1 and outer walls of long end surfaces on two sides of the inner casing 2, and the two sides of the outer casing 1 are fixed on the two sides of the inner casing 2 in a detachable connection mode, or can be fixed between a top plate 6 and the base 3 in a snap-fitting connection mode.

The outer casing 1 is made of transparent material, therefore, when observing the loudspeaker device from the outside, the user can see an outer wall of the inner casing 2 through the outer casing 1. When in use, the user can view the light-emitting effect of the inner casing 2 through the outer casing 1.

It is worth noting that a difference between translucent and transparent defined above lies in: translucent inner casing means that the internal structure of the inner casing cannot be seen, but the light can be dispersed through the inner casing, so that the inner casing produces a light-emitting effect as a whole; and transparent outer casing means that components inside the outer casing can be seen through the outer casing (for example, the inner casing can be seen through the outer casing), and the light of the inner casing can be transmitted to the outside through the outer casing. In other optional embodiments, the outer casing can further be configured to be translucent same as that of the inner casing, which can be selected according to actual needs. Therefore, “translucent” and “transparent” in the present disclosure should be determined according to the display effect/degree.

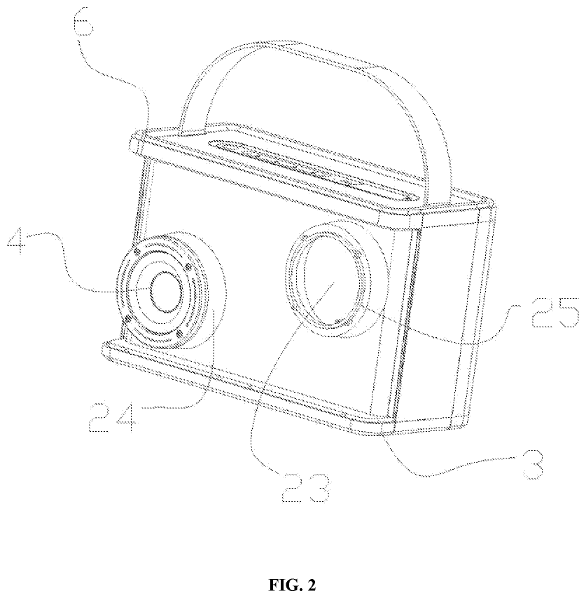

As shown in FIG. 2, the top plate 6 is arranged at the top of the loudspeaker device, the top plate 6 is fixed at the top of the inner casing 2 in a detachable connection mode, a button slot 61 is formed on the top plate 6, buttons and a PCB board are arranged inside the button slot 61, a power supply is arranged inside the loudspeaker device, electronic components of the light-emitting device 5 are electrically connected to one another, so that the user can adjust the light-emitting effect, volume, and the like, through the light-emitting device 5, and the power supply supplies power to the light-emitting device 5 and a speaker 4. Arrangement methods of the components are common to those skilled in the art, which will not be repeated here. The base 3 is provided with a power supply bin for accommodating a power supply, and more specifically, the loudspeaker device is further provided with a charging port that allows the loudspeaker device to be charged through an external power supply.

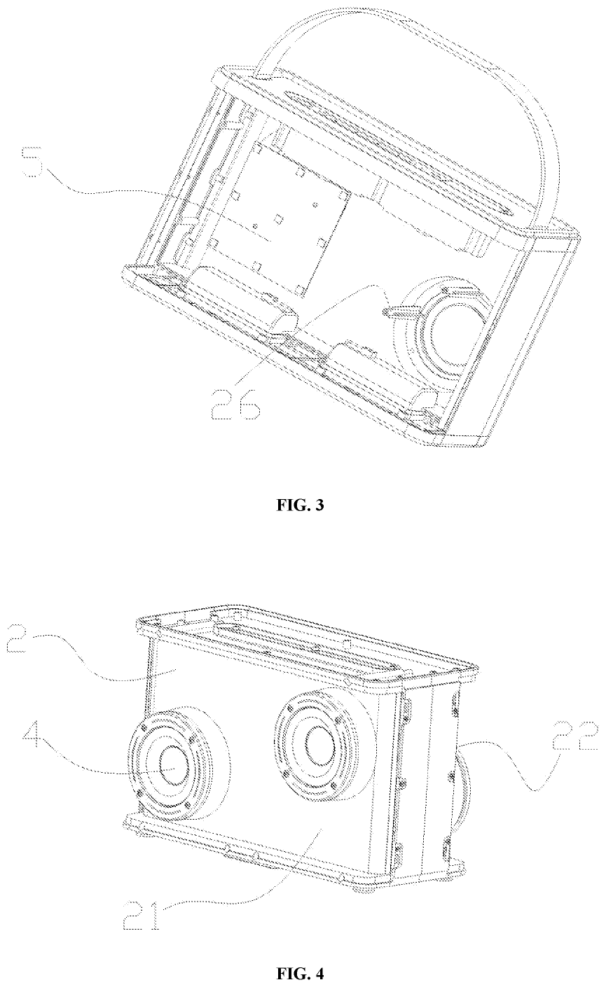

As shown in FIG. 3, in this embodiment, the light-emitting device 5 is a lamp panel, where the lamp panel is vertically fixed on the connecting segments 26 inside the inner casing 2 in a detachable connection mode, since the connecting segments 26 inside the inner casing 2 extends transversally, the lamp panel can be placed in a centered position of the inner casing 2 by controlling a length of the connecting segments 26 when the lamp panel is fixed on the connecting segments 26, so that the inner casing 2 has a better light-emitting effect.

As shown in FIG. 2, a first through hole 23 for accommodating the speaker 4 is formed on the long end surfaces on the two sides of the inner casing 2, and the speaker 4 is fixed on the first through hole in a detachable connection mode. The inner casing 2 is provided with an outward extension position 24 outwardly extending at the first through hole, and the outward extension position 24 and the inner casing 2 are integrally formed.

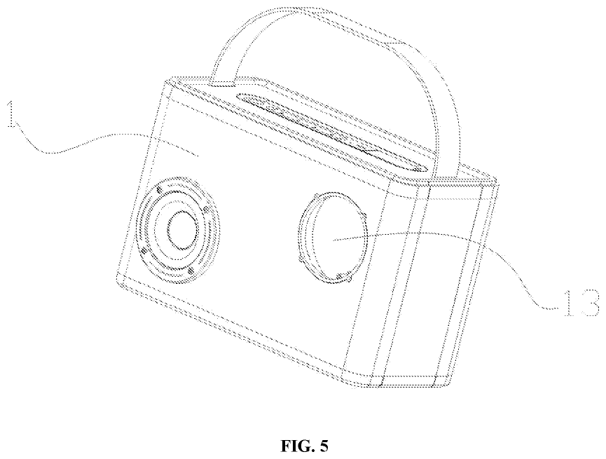

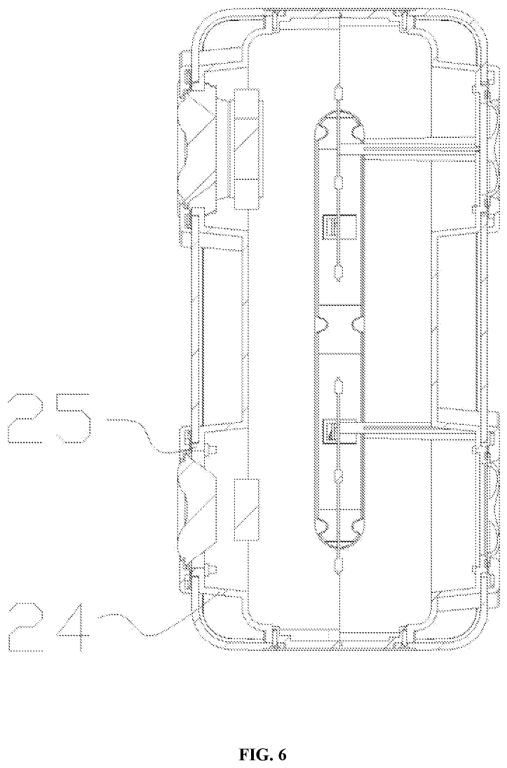

As shown in FIGS. 5-6, as stated above, a certain spacing is reserved between inner side surfaces on the two sides of the outer casing 1 and outer side surfaces on the two sides of the inner casing 2 for accommodating the outward extension position 24. It is worth noting that when the speaker 4 is mounted on the outward extension position 24, the outward extension position 24 will wrap around the speaker 4. A second through hole 13 is formed at a position of the outer casing 1 corresponding to the first through hole 23 of the inner casing 2 for accommodating/securing the penetration of the speaker 4. A function of the first through hole and the second through hole is to enable the formation of a mutually penetrating channel between the inner casing and the outer casing, so that the loudspeaker can be disposed in the channel and secured to the first through hole and/or the second through hole.

In this embodiment, a diameter of the outward extension position 24 is greater than that of the second through hole 13; and in other optional embodiments, a diameter of the outward extension position 24 can be slightly smaller than that of the second through hole 13. In this embodiment, an end portion of the outward extension position 24 is butted against inner walls of the outer casing 1, a necking 25 with a diameter smaller than that of the outward extension position 24 and the second through hole 13 is formed on the end portion of the outward extension position 24, and the necking 25 can pass through and is substantially butted against inner walls of the second through hole 13 of the outer casing 1, such that the outward extension position 24 can wrap around the speaker 4 better.

The outward extension position ensures wrapping around the speaker, so that the user cannot see the speaker inside the loudspeaker structure when the loudspeaker device in the light-emitting state, and when the inner casing together with the outward extension position is emitting the light as a whole, an exterior side surface of the inner casing show a planar state (caused by visual difference), this is because people take a side of the outward extension position so viewed as a side surface of the inner casing. In this case, people can only see the speaker at the outer casing, while the speaker at the inner casing is wrapped by the outward extension position. As stated above, the side surface of the inner casing show a planar state as a whole, therefore, when the use looks at the speaker, it appears that the speaker is in a suspended state with a visual effect.

In a preferred embodiment, the necking at the end portion of the outward extension position is embedded in the inner walls of the second through hole, which ensures a stable connection between the outward extension position and the outer casing, further improves the wrapping around the speaker by the outward extension portion, and avoid a gap that affects the suspended and hidden effect of the speaker between the outward extension portion and the inner walls of the outer casing.

The number of the first through hole 23 and the second through hole 13 can be determined according to the actual situation, and is not specifically limited here.

When the loudspeaker device is in the light-emitting state, that is, when the light-emitting device 5 is in the light-emitting state, the inner casing 2 present a light-emitting effect as a whole, in which case, an outer end surface of the outward extension position 24 will also at a light-emitting state. Further, since the outward extension portion 24 and the inner casing 2 are integrally formed, when the inner casing 2 is in the light-emitting state, the user will not see a corner where the outward extension portion 24 is connected to an end surface of the inner casing 2 and an outer end surface of the outward extension portion 24, but will see that an entire side of the inner casing 2 is in the light-emitting state.

In the light-emitting state, although a through hole is formed on the inner casing 2, and the outward extension position is arranged on the through hole, the user will only see an outer side of the outward extension position when viewing it from a front or from a side. A certain visual difference will produce, causing the user to think that the side surface of the inner casing 2 is arranged in a planar mode. Since the outer side of the inner casing 2 and the outward extension portion 24 viewed by the user are planar when the loudspeaker device is in the light-emitting state, therefore, when the above visual effect is produced, the speaker 4 of the loudspeaker device will give the user a suspended visual effect equivalent to a fact that the speaker 4 is arranged only on the outer casing 1, the inner casing 2 of the loudspeaker device is considered to be planar, which is a visual effect incapable of being brought about by existing loudspeaker devices.

Further, cover plates 7 are arranged on the loudspeaker device, the cover plates 7 are fixed on both sides of the loudspeaker device for covering the splicing position of the first inner casing 21 and the second inner casing 22, and the connection position between the inner casing 2 and the outer casing 1, such that an overall structure of the loudspeaker device becomes more beautiful.

A carrying handle 8 is disposed at the top of the loudspeaker device, which is convenient for the user to carry the loudspeaker device, and in this embodiment, the carrying handle 8 and the top plate 6 are connected and fixed to each other.

The description of various embodiments of the present disclosure is expressed for purposes of illustration, and not intended to limit the disclosed embodiments, many modifications and variations will be apparent to those of ordinary skill in the art without departing from the scope and spirit of the described embodiments, and the terms used in the embodiments are used to best explain the principles and practical applications of the embodiments, or to enable other persons of ordinary skill in the art to understand the embodiments disclosed herein, and are not intended to be construed as limitations of the present disclosure.

The loudspeaker device provided by the embodiments of the present disclosure has been described in detail above. Various modifications can be made by those of ordinary skill in the art to specific implementation modes and their application scopes in accordance with the ideas of the present disclosure. Therefore, the content of the present specification should not be construed as limiting the present disclosure.

In the specification of the present disclosure, it should be understood that orientation or position relationships indicted by the terms “length”, “width”, “upper”, “lower”, “middle”, “front”, “rear”, “left”, “right”, “vertical”, “horizontal”, “top”, “bottom”, “interior”, “exterior” and the like are based on orientation or position relationships shown in the drawings, merely for the convenience of describing the present disclosure and simplifying the description, instead of indicating or implying that the indicated device or element must have particular orientations or be constructed and operated in particular orientations. Therefore, these terms cannot be construed as a limitation to the present disclosure.

In the present disclosure, unless otherwise explicitly specified and defined, the terms “mounting”, “connecting”, “connection”, “fixing”, etc. should be understood in a broad sense, for example, they may be a fixed connection, a detachable connection, or an integrated connection; may be a mechanical connection, or an electrical connection; may be a direct connection, or an indirect connection via an intermediate medium; and may be communication inside two elements, or an interactive relation between two elements. Those of ordinarily skilled in the art can understand specific meanings of the above terms in the present disclosure according to specific circumstances.

What is claimed is:

1. A loudspeaker device, comprising a translucent inner casing (2), and a transparent or translucent outer casing (1) fixed on an outer side of the inner casing (2), a light-emitting device (5) being fixed inside the inner casing (2), the outer casing (1) and the inner casing (2) each being provided at least one through hole, and an outward extension position (24) extending outwardly being arranged on the through hole of the inner casing.

2. The loudspeaker device according to claim 1, wherein the through holes are at least one second through hole (13) formed on the outer casing (1) and at least one first through hole (23) formed on the inner casing, and the first through hole (23) and the second through hole (13) are penetrated through each other.

3. The loudspeaker device according to claim 2, wherein the outward extension position (24) is arranged on an outer side of the first through hole (23), and a necking (25) extending to the second through hole (13) is formed on an end portion of the outward extension position (24).

4. The loudspeaker device according to claim 1, wherein at least one connecting segment (26) connected to the light-emitting device is arranged inside the inner casing (2).

5. The loudspeaker device according to claim 1, wherein the inner casing (2) comprises a first inner casing (21) and a second inner casing (22), and the outer casing (1) comprises a first outer casing (11) and a second outer casing (12).

6. The loudspeaker device according to claim 5, wherein the first outer casing (11) and the second outer casing (12) are fixed on the outer side of the inner casing (2).

7. The loudspeaker device according to claim 1, wherein cover plates (7) are fixed on both sides of the outer casing (1) and the inner casing (2).

8. The loudspeaker device according to claim 1, wherein a top plate (6) is fixed on the top of the inner casing (2), and a base (3) is fixed on the bottom of the inner casing (2).

9. The loudspeaker device according to claim 2, wherein a speaker (4) is fixed on the first through hole (23) and the second through hole (13).

10. The loudspeaker device according to claim 9, wherein a part of the speaker (4) located inside the loudspeaker device is arranged inside on an inner side outward extension position (24).
